(19) United States
(12) Patent Application Publication
(10) Pub. No.: US 2012/0070123 A1
(43) Pub. Date: Mar. 22, 2012

(54) Method of evaluating snow and board sport equipment

(76) Inventor: Robett David Hollis, Dargaville (NZ)

(21) Appl. No.: 12/886,253

(22) Filed: Sep. 20, 2010

(51) Int. Cl. H04N 5/77

(52) U.S. Cl. 386/224; 386/E05.003

(57) ABSTRACT

A method of evaluating snow and board sport equipment. The method includes an evaluator using the equipment and orally describing perceptions arising while using it, for example by means of a wireless microphone. A video image is made of the evaluator using the equipment, and this video image is combined with the oral description to create an audio-visual evaluation of the sport equipment.

### BACKGROUND

Snow sport equipment, especially various kinds of skis and snowboards, has been growing in popularity and in variety. For example, once there were but few kinds of skis and only one or two kinds of boots; today there are powder skis, racing skis, freestyle skis, and all-mountain skis to name but a few. There are dozens of designs of boots, and even ski poles now come in various constructions each with its own characteristics. Similarly, there are carving snowboards, racing snowboards, half-pipe snowboards, terrain park snowboards, snowboards with reverse camber, and even split snowboards that can be used like skis for cross-country travel.

There are other devices that can be used for recreation on the snow. Examples include ski bikes, cross-country skis, Nordic ski equipment, and the like. There are also many different kinds of surfboards, wakeboards, kiteboards, and even skateboards from which a purchaser may choose.

It is known for experienced users, for example expert snowboarders, to test various kinds of sport equipment and then afterwards write product reviews. These reviews sometimes serve as feature articles in specialty magazines and are often used by purchasers for assistance in selecting sport equipment.

There has been a need for an instantaneous, dynamic presentation of the characteristics of snow and board sport equipment as those characteristics are being experienced by a user.

### SUMMARY

The invention resides in a method of evaluating snow and board sport equipment by an evaluator using the sport equipment. The evaluator orally describes perceptions arising from use of the sport equipment, while the evaluator is using it. The evaluator's oral description is captured electronically. A video image is made of the evaluator using the equipment. The oral description and the video image are combined to create an audio-visual evaluation of the equipment.

### BRIEF DESCRIPTION OF THE DRAWINGS

FIG. 1 is a flowchart illustrating an embodiment of the invention.

FIG. 2 shows an evaluator evaluating skis according to an embodiment of the invention.

FIG. 3 shows an evaluator evaluating a snowboard according to an embodiment of the invention.

In the drawings, the same reference numerals are used for similar elements and different numerals are used for different elements.

### DESCRIPTION OF EMBODIMENTS

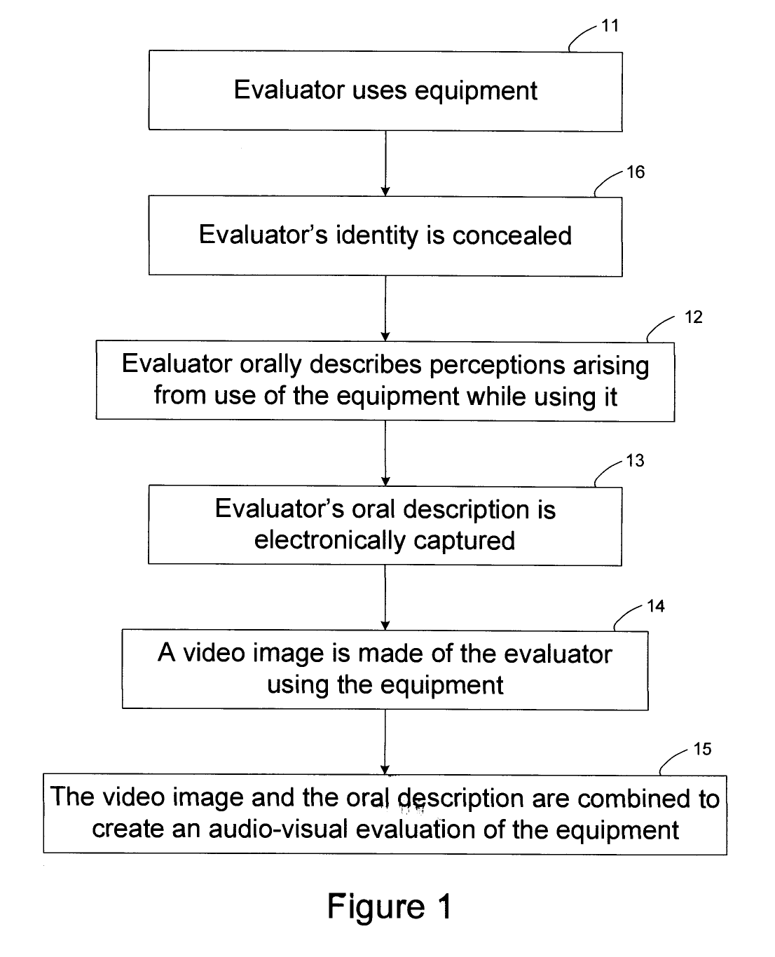

As shown in FIG. 1, an embodiment of the invention provides a method of evaluating snow and board sport equipment. The method includes use of the sport equipment by the evaluator (block 11). The evaluator orally describes perceptions arising from use of the sport equipment while using it (block 12). The evaluator's oral description is electronically captured (block 13). A video image is made of the evaluator using the sport equipment (block 14). The oral description and the video image are combined to create an audio-visual evaluation of the sport equipment (block 15).

In some embodiments the evaluator's identity is concealed (block 16). Concealing the identity of the evaluator can add excitement to the audio-visual evaluation. The viewer might be invited to attempt to figure out who is the evaluator, perhaps by selecting from among a group of well-known professionals in the particular sport. The evaluator's identity may be concealed by covering the evaluator's face. A mask could be used, or the evaluator could be dressed in a disguise, or the evaluator could simply be covered from head to foot in clothing of a single color such as black. The evaluator's identity may be concealed by disguising the evaluator's voice. This could be done by the evaluator deliberating speaking in an unusual manner or with an affected accent, or it could be done electronically by distorting or filtering the evaluator's voice.

An artificial persona, such as “the mystery rider” or “the all black skier” could be created as a means of disguising the identity of the evaluator.

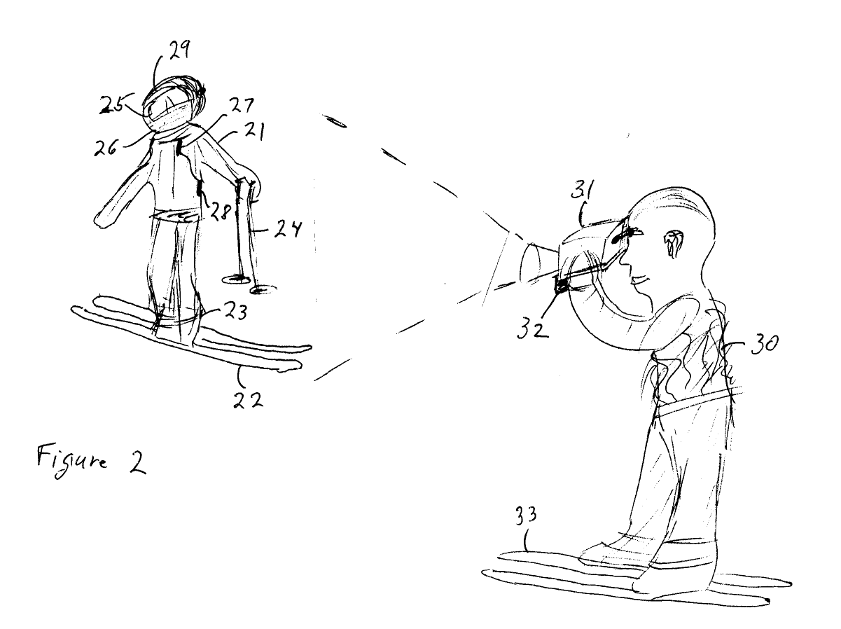

FIG. 2 shows an evaluator 21 testing a pair of skis 22. The evaluator is wearing ski boots 23 and carrying ski poles 24. The evaluator may be evaluating the skis, the boots, the poles, or any combination thereof. The evaluator is wearing ski goggles 25. A scarf or other covering 26 may conceal the evaluator's face.

The evaluator is wearing a microphone 27 connected to a transmitter 28. The microphone captures the evaluator's comments and transmits them through the transmitter to a remote location. The microphone may be clipped on to the evaluator's clothing, worn on a necklace, attached to the evaluator's helmet 29, or carried or attached in some other way as may be convenient. In some embodiments the microphone may be a directional microphone located away from, and focused in the direction of, the evaluator.

A video operator 30 is carrying a video camera 31. The video camera may include a built-in receiver to receive audio from the transmitter, or the video camera may be connected to a separate receiver 32. In some embodiments the video camera may not get the audio at all, and instead the audio and video are both transmitted to another location and there combined.

The camera may be in communication with a base station either through a cable (not shown) or another transmitter (not shown). Or the camera may include a video recorder that captures the video image of the evaluator and the audio for later playback.

The video operator may stand still. Or the video operator may follow the evaluator. If the evaluator is on skis or a snowboard, the video operator may also use skis 33 to follow the evaluator.

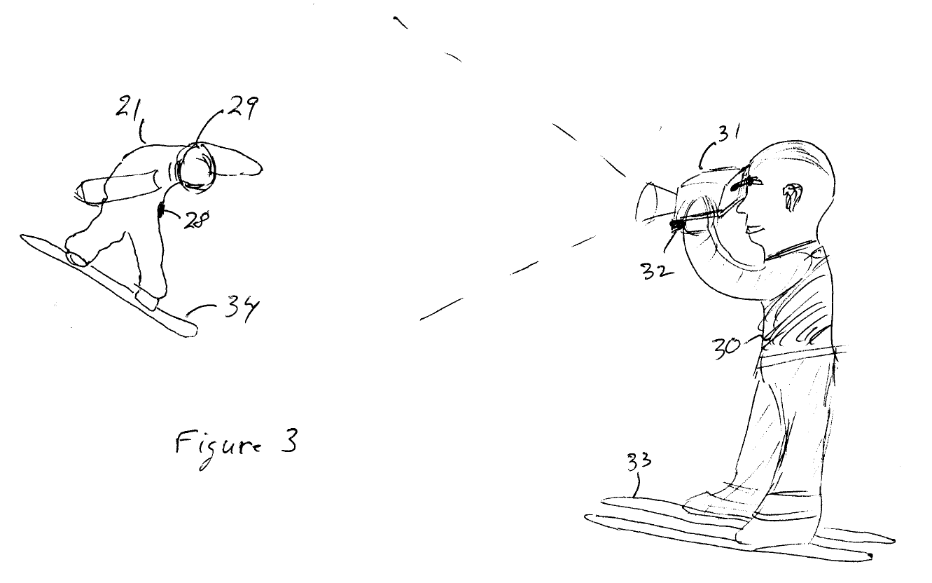

FIG. 3 is similar to FIG. 2 but shows the evaluator testing a snowboard 34 rather than skis. The evaluator may test other snow sport equipment, for example a snow bike (a frame, attached to skis or a snowboard, that carries a user), Nordic skis, cross-country skis, ultra-short skis, a kiteboard, or any other similar device by which a user slides across or down the snow.

In some embodiments the evaluator may test a wakeboard, a surfboard, a wind-surfing setup, or other similar device by which a user rides across the water, or a skateboard, roller skates, or the like.

When the audio and video are combined in real time, either at the video camera or at a remote location, the result is an audio-visual presentation that may be presented live, either locally or by broadcast to a remote audience. Or the presentation may be recorded, for example on video tape or DVD, for later viewing. In other embodiments the audio and video may be edited separately or together to provide an edited audio-visual presentation. Such a presentation may be viewed when completed, or it may be stored on a DVD or other medium.

Embodiments of the invention make it possible to test board sport and snow sport equipment using a wireless microphone attached to the evaluator. The evaluator gives an instant live commentary describing the response, aesthetics, technical feel and other characteristics of the equipment while using the equipment in its natural sporting environment. While the equipment is being used, the evaluator describes what the evaluator is doing to the equipment, how the evaluator is attempting to control it, and the like, while also giving instant feedback describing how the equipment responds, what it feels like, how easy or hard it is to control the equipment, and the like.

As described above, the identity of the evaluator may be concealed by wearing a mask or covering the face or entire body of the evaluator. Or the evaluator's identity may be concealed during or after the making of the video image by distorting or altering the image, such as by mottling or blurring the portion of the image that includes the evaluator's face.

I claim:

1. A method of evaluating snow and board sport equipment, the method comprising:
an evaluator using the sport equipment;
the evaluator orally describing perceptions arising from use of the sport equipment while using it;
capturing the evaluator's oral description electronically;
making a video image of the evaluator using the sport equipment; and
combining the oral description and the video image to create an audio-visual evaluation of the sport equipment.

2. A method as in claim 1 and further comprising concealing the evaluator's identity.

3. A method as in claim 2 wherein concealing the evaluator's identity comprises covering the evaluator's face.

4. A method as in claim 2 wherein concealing the evaluator's identity comprises disguising the evaluator's voice.

5. A method as in claim 4 wherein disguising the evaluator's voice comprises electronically distorting the evaluator's voice.

6. A method as in claim 2 wherein concealing the evaluator's identity comprises projecting an artificial persona for the evaluator.

7. A method as in claim 1 wherein the video image is made by a video camera.

8. A method as in claim 1 wherein capturing the oral description comprises using a microphone carried by the evaluator.

9. A method as in claim 8 wherein the evaluator carries the microphone by attaching it to an article of clothing.

10. A method as in claim 8 wherein the video image is made by a video camera and the video camera is in electronic communication with the microphone.

11. A method as in claim 10 wherein the microphone comprises a radio transmitter in wireless electronic communication with the video camera.

12. A method as in claim 1 wherein the sport equipment comprises a snowboard.

13. A method as in claim 1 wherein the sport equipment comprises skis.

14. A method as in claim 1 wherein the sport equipment comprises a device that carries a rider in sliding motion on snow.

15. A method as in claim 1 wherein the sport equipment comprises a surfboard.

16. A method as in claim 1 wherein the sport equipment comprises a wakeboard.

17. A method as in claim 1 wherein the sport equipment comprises a skateboard.

18. A method as in claim 1 wherein the sport equipment comprises a kiteboard.
